(19) United States
(12) Patent Application Publication
(10) Pub. No.: US 2002/0174145 A1
(43) Pub. Date: Nov. 21, 2002

(54) AUTOMATIC DATA FORMATTING USING A HYPERTEXT LANGUAGE

(76) Inventors: BRADY DUGA, CARLSBAD, CA (US); WILLIAM SCOTT LESHNER, CARLSBAD, CA (US); ERIK WALTER, LA JOLLA, CA (US); ALEKSEY NOVICOV, PALO ALTO, CA (US); GARTH CONBOY, LA JOLLA, CA (US); ANDREW MARDER, SAN DIEGO, CA (US); TINA MARIE DUSSAULT, MOUNTAIN VIEW, CA (US); DEVIN PATRICK MCKINNEY, PALO ALTO, CA (US); JAMES SACHS, MENLO PARK, CA (US)

Correspondence Address: KEVIN T LEMOND, TOWNSEND AND TOWNSEND AND CREW, TWO EMBARCADERO CENTER 8TH FLOOR, SAN FRANCISCO, CA, 94111, US

(21) Appl. No.: 09/173,988

(22) Filed: Oct. 16, 1998

(51) Int. Cl. G06F 15/00

(52) U.S. Cl. 707/513

(57) ABSTRACT

The present invention is a method and apparatus for automatic formatting a hypertext document. The hypertext document is parsed to identify a formatting tag. A tag operation is performed on the hypertext document according to the identified formatting tag to generate a formatted document.

### BACKGROUND

1. Field of the Invention

This invention relates to electronic books. In particular, the invention relates to data formatting using a hypertext language.

2. Description of Related Art

Advances in computer and communication technology have provided the consumers a convenient and economical means to access information in a variety of media. One particular area of information access is the electronic books. An electronic book is a virtual device that receives printed materials downloaded from an information network. A user of an electronic book can read downloaded contents of books and printed materials subscribed from a participating bookstore at his or her own convenience without the need to purchase the printed copies of the books.

The World Wide Web (WWW) has now become a popular means for publishing printed materials in the open network domain. The WWW refers to the abstract cyberspace of information which is transmitted over the physical networks, such as the Internet. The WWW publishing works under a client-server model. A Web server is a program running on a server to serve documents to other computers or devices that send requests for the documents. A Web client is a program that lets the user request document from a server. To facilitate the downloading of printed materials, the contents of these documents are typically created in a form compatible with network transmission format. The document the server sends is in a hypertext language format. A popular hypertext language is the HyperText Markup Language (HTML).

The HTML is a fairly limited formatting language. A document produced by a word processing package may lose many of its styles and formats when tailored into the HTML format. For example, control of margins, indents, fonts, and tables may be lost. If the documents are part of a book, many of the page layout and text formatting features of the documents may be lost, resulting in reading difficulty and sometimes loss of information continuity and clarity.

Therefore there is a need in the technology to provide a simple and efficient method to perform automatic data formatting for documents created with a hypertext language.

### SUMMARY

The present invention is a method and apparatus for automatic formatting a hypertext document. The hypertext document is parsed to identify a formatting tag. A tag operation is performed on the hypertext document according to the identified formatting tag to generate a formatted document.

### BRIEF DESCRIPTION OF THE DRAWINGS

The features and advantages of the present invention will become apparent from the following detailed description of the present invention in which:

FIG. 1 is a diagram illustrating a system in which one embodiment of the invention can be practiced.

FIG. 2 is a diagram illustrating an environment for automatic data formatting according to one embodiment of the invention.

FIG. 3 is a flowchart illustrating a process to perform tags according to one embodiment of the invention.

FIG. 4A is a flowchart illustrating a process to perform a page break operation according to one embodiment of the invention.

FIG. 4B is a flowchart illustrating a process to perform a header operation according to one embodiment of the invention.

FIG. 4C is a flowchart illustrating a process to perform a footer operation according to one embodiment of the invention.

FIG. 4D is a flowchart illustrating a process to perform a font operation according to one embodiment of the invention.

FIG. 4E is a flowchart illustrating a process to perform an image operation according to one embodiment of the invention.

FIG. 4F is a flowchart illustrating a process to perform a body operation according to one embodiment of the invention.

FIG. 4G is a flowchart illustrating a process to perform a text-containing operation according to one embodiment of the invention.

FIG. 4H is a flowchart illustrating a process to perform a link operation according to one embodiment of the invention.

FIG. 4I is a flowchart illustrating a process to perform a form operation according to one embodiment of the invention.

### DESCRIPTION

The present invention is a method and apparatus for automatic data formatting using a hypertext language. The technique includes the use of a parser and a paginator that process the hypertext language source program. The parser recognizes the tags and perform the functions according to the tags. Data formatting tags include page break, header, footer, font, image, body, text-containing, link, and form tags. The technique provides readability, clarity, and richness to the document.

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

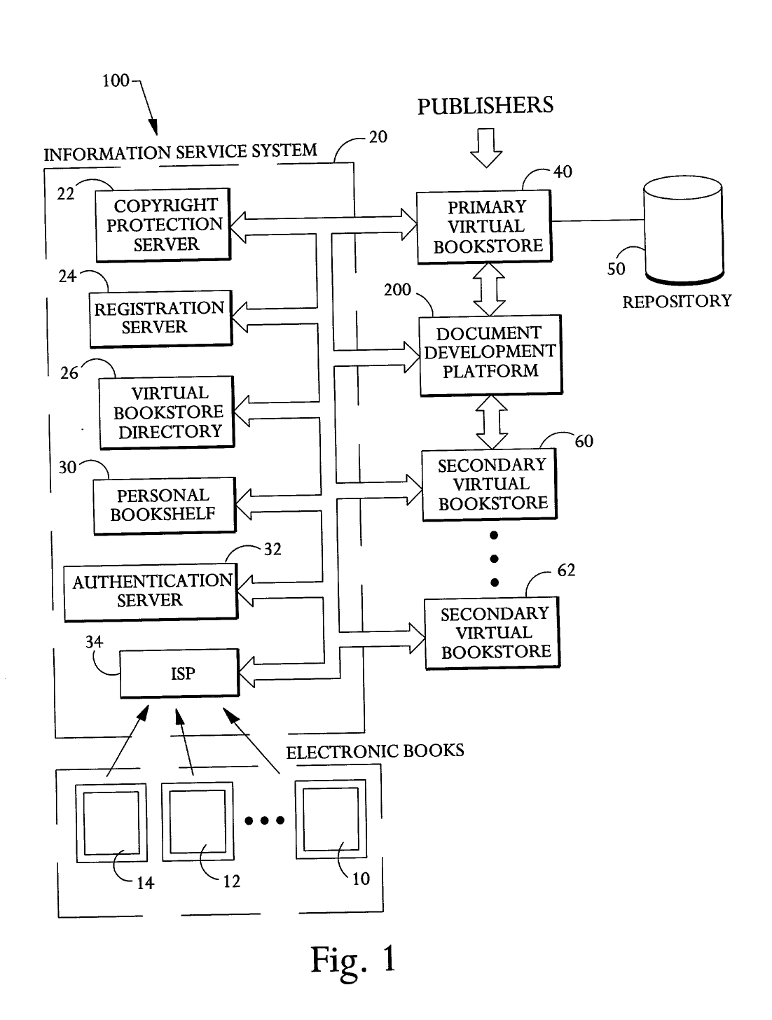

FIG. 1 is a diagram illustrating a system 100 in which one embodiment of the invention can be practiced.

Referring to FIG. 1, the system 100 comprises: (a) at least one portable electronic book 10 operative to request a digital content from a catalog of distinct digital contents, to receive and display the requested digital content in readable form; (b) an information services system 20 which includes an authentication server 32 for authenticating the identity of the requesting portable electronic book 10 and a copyright protection server 22 for rendering the requested digital content sent to the requesting portable electronic book 10 readable only by the requesting portable electronic book 10; (c) at least one primary virtual bookstore 40 in electrical communication with the information services system 20, the primary virtual bookstore being a computer-based storefront accessible by the portable electronic book and including the catalog of distinct digital contents; and (d) a repository 50, in electrical communication with the primary virtual bookstore 40, for storing the distinct digital contents listed in the catalog.

The system 100 preferably includes more than one portable electronic book 10, to be commercially viable. This is illustrated in FIG. 1 by including the portable electronic books 12 and 14. The system also preferably includes more than one primary virtual bookstore 40, each serving a different set of customers, each customer owning a portable electronic book.

In one embodiment of the invention, the system 100 further comprises a secondary virtual bookstore 60 in electrical communication with the information services system 20. In this case, the information services system 20 also includes a directory of virtual bookstores 26 in order to provide the portable electronic book 10 with access to the secondary virtual bookstore 60 and its catalog of digital contents.

The information services system 20 can optionally include a notice board server 28 for sending messages from one of the virtual bookstores, primary or secondary, to a portable electronic book in the system.

The information services system 20 also includes a registration server 24 for keeping track of the portable electronic books that are considered active accounts in the system and for ensuring that each portable electronic book is associated with a primary virtual bookstore in the system. In the case where the optional notice board server 28 is included in the information services system 20, the registration server 24 also allows each portable electronic book user to define his/her own notice board and document delivery address.

The information services system 20 preferably comprises a centralized bookshelf 30 associated with each portable electronic book 10 in the system. Each centralized bookshelf 30 contains all digital contents requested and owned by the associated portable electronic book 10. Each portable electronic book 10 user can permanently delete any of the owned digital contents from the associated centralized bookshelf 30. Since the centralized bookshelf 30 contains all the digital contents owned by the associated portable electronic book 10, these digital contents may have originated from different virtual bookstores. The centralized bookshelf 30 is a storage extension for the portable electronic book 10. Such storage extension is needed since the portable electronic book 10 has limited non-volatile memory capacity.

The user of the portable electronic book 10 can add marks, such as bookmarks, inking, highlighting and underlining, and annotations on a digital content displayed on the screen of the portable electronic book, then stores this marked digital content in the non-volatile memory of the electronic book 10. The user can also upload this marked digital content to the information services system 20 to store it in the centralized bookshelf 30 associated with the portable electronic book 10, for later retrieval. It is noted that there is no need to upload any unmarked digital content, since it was already stored in the centralized bookshelf 30 at the time it was first requested by the portable electronic book 10.

The information services system 20 further includes an Internet Services Provider (ISP) 34 for providing Internet network access to each portable electronic book in the system.

FIG. 1 further illustrates that the primary virtual bookstore 40 and the secondary virtual bookstore 60 interact with a document development platform 200. The document development platform 200 generates the formatted documents to be transmitted to the information service system 20 for downloading to the electronic books 10, 12, and 14.

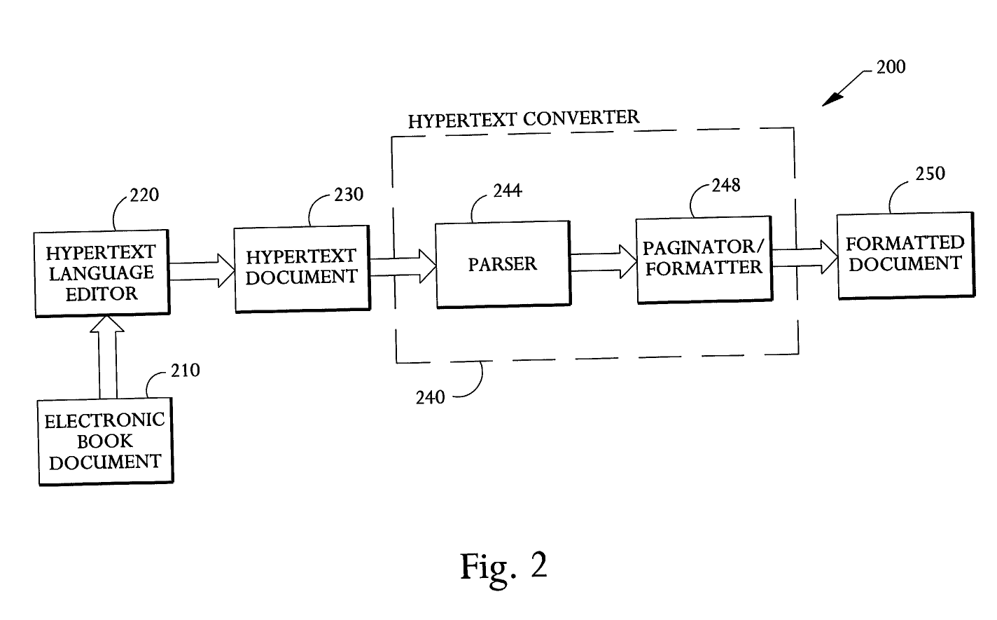

FIG. 2 is a diagram illustrating the document development platform 200 for automatic data formatting according to one embodiment of the invention. The document development platform 200 includes an electronic book document 210, a hypertext language editor 220, a hypertext document 230, a hypertext converter 240, and a formatted document 250.

The hypertext converter 240 may be implemented by a computer program written in any language embodied on a machine readable medium. Examples of such machine readable medium include semiconductor memories, magnetic medium, compact disk read only memory (CDROM), floppy diskette, hard disk, optical disk, signals, carrier waves, etc. The computer program or software is processed by a processor to automatically format the hypertext document 230. The computer program includes a number of code segments, sub-programs, sub-routines, or functions to perform a number of operations. Examples of these operations include parsing the hypertext document to identify a formatting tag, and performing a tag operation on the hypertext document according to the identified formatting tag to generate the formatted document 250. Additional code segments are used to perform other functions as explained further in the following.

The electronic book document 210 is a document to be created to become a hypermedia document for transmitted over the communication network from a server to a receiving client such as an electronic book. The electronic book document 210 may include text, graphic, and image data. The electronic book document 210 may be originally created by any convenient means, including word processor, scanner with character recognition, or manual entry.

The hypertext language editor 220 is a program that allows the creation of the hypertext document incorporating the electronic book document 210. In one embodiment, the hypertext language editor 220 is a HyperText Markup Language (HTML) editor. The hypertext document 230 is a document created with the hypertext language. The hypertext language 230 includes hypertext constructs such as tags, attributes and values embedded in the document.

The hypertext converter 240 converts the hypertext document 230 into the formatted document 250. The hypertext converter 240 includes a parser 244 and an paginator/formatter 248. The parser 244 analyzes the syntax of the hypertext document 230 and identifies the tags, attributes, and values contained in the hypertext document 230. The parser 244 is essentially a state machine that examines the hypertext document 230 and looks for relevant keywords such as tags, attributes, and values. The parser 230 may also check for errors and provide default characteristics or values. The paginator/formatter 248 receives the result of the parser 244 and process the document accordingly. The paginator/formatter 248 performs operations that are specified by the parsed information (e.g., tags) or automatically when necessary. The paginator/formatter 248 can automatically insert a page break in a document when it determines that a page break is necessary to improve the readability of the document. The paginator/formatter 248 keeps track of the height of the page and the number of lines on a page. A page break can be automatically inserted when the number of lines on a page reaches a certain maximum value or when a new section or header is inserted or when the page reaches the end of a section or chapter.

The formatter document 250 is a document that has been formatted by the hypertext converter 240. The formatted document 250 provides readability and clarity to the hypertext document 230.

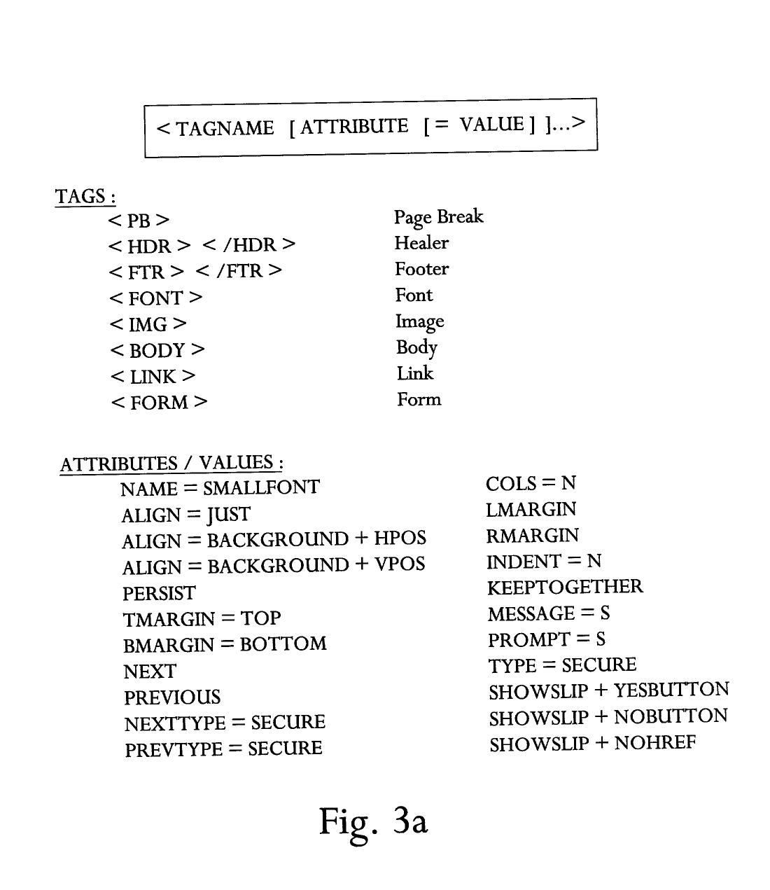

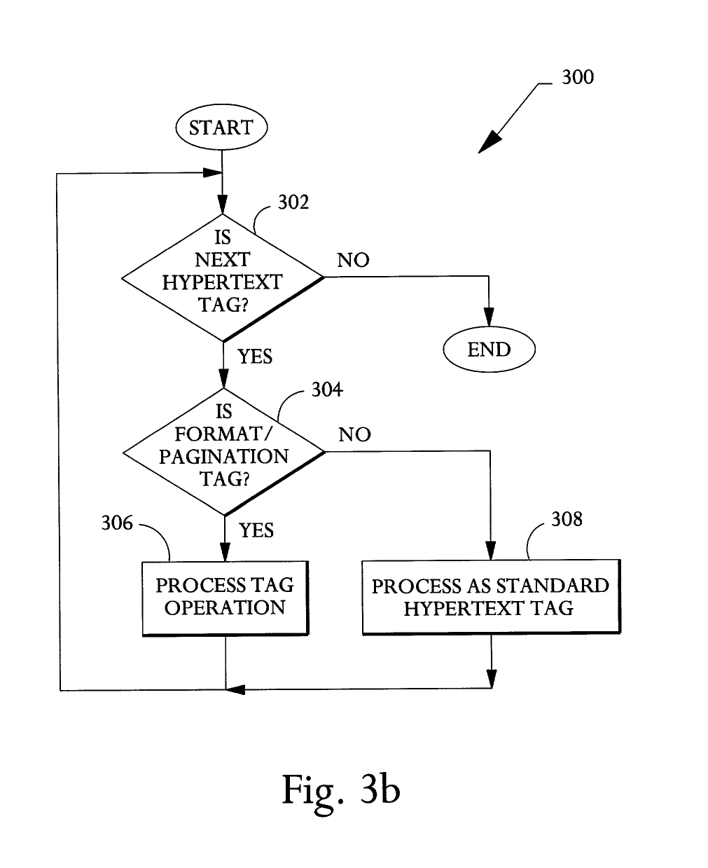

FIG. 3A is a diagram illustrating the format of the hypertext tag according to one embodiment of the invention.

The format of a tag includes a tag name, an optional attribute name, and an optional value for the attribute.

The following are examples of tags that are used to format the document: <PB> (Page break), <HDR> . . . </HDR> (Header), <FTR> . . . </FTR> (Footer), <FONT> (Font), <IMG> (Image), <BODY> (Body), <LINK> (Link), <FORM> (Form), <MENU> . . . </MENU> (Menu), <MENUITEM> (Menu items), <VPPAGING> (Paging).

The <PB> tags indicate a page break, allowing the content creator to insert hard page breaks. Typically this is used at the end of a chapter or section, to force the next chapter or section to appear starting on a fresh page. The <PB> tag may also be automatically inserted by the paginator/formatter 248 (FIG. 2) when it is determined that a page break is necessary.

The <HDR> indicates a page header. Any hypertext enclosed by a <HDR> . . . </HDR> pair will be displayed at the top of all subsequent pages, until the header is reset by another <HDR> . . . </HDR> pair.

The <FTR> indicates a footer. Any hypertext enclosed by a <FTR> . . . </FTR> pair will be displayed at the bottom of all subsequent pages, until the header is reset by another <FTR> . . . </FTR> pair.

The <MENU> allows the bookstore to dynamically set the appearance and behavior of the menu on the electronic book. It can specify a known starting template menu to be used for that page and it may contain <MENUITEM> tags.

The <MENUITEM> tags are contained in the <MENU> . . . </MENU> tag pairs. This allows the editing of the specific items in the soft menu (i.e., setting icons, commands, and parameters). Special attributes of this tag are: CMD, PARAM, PICTID. The CMD attribute sets a numeric command to execute. The PARAM attribute indicates any special parameters for the operation. The PICTID indicates which read-only memory (ROM)-based image to be used a s icon.

The <VPPAGING> is a special tag that allows page global settings to appear at the end of a document, instead of the beginning. It behaves like a <BODY> tag but it can appear after all other text in the file. This is used to facilitate the bookstore specification of NEXT/PREV attributes. It differs in the other tags in that it does not alter the hypertext for viewing on a book-based device, but is added to ease the development of the bookstore.

The following are examples of attributes and values:

NAME=SMALLFONT: The attribute NAME is used with the tag <FONT>, the SMALLFONT is the value for the attribute NAME to signify a small font size is to be used for the font. In one embodiment, this small font size is 9-point size.

ALIGN=JUST: The ALIGN attribute with a value of JUST in a tag causes the enclosed text to be justified or aligned with both left and right margins.

ALIGN=BACKGROUND+HPOS/VPOS: The ALIGN attribute in the <IMG> tag with a value of BACKGROUND causes that image to be the background image for the page it was on. There can be multiple background images on a page and text can be drawn over them. Using HPOS and VPOS in the same tag allows precise horizontal and vertical placement of the image relative to the page or the other container.

PERSIST: The PERSIST attribute in an <IMG> tag that is set to be a background image causes that image to appear on all subsequent pages, not just the page it was set on.

TMARGIN/BMARGIN=x: The TMARGIN/BMARGIN attributes set margins with value “x” on a global basis for the document. The TMARGIN/BMARGIN specify the top and bottom margins, respectively.

NEXT/PREV: The NEXT/PREV attributes allow the bookstore to assign links to follow for the next and previous buttons. These attributes preserve the book “page flipping” metaphor.

TYPE=SECURE: The TYPE attribute with a value of SECURE is used for links and identifies links that require authentication for use with the electronic book. For BODY and other tags that have NEXT or PREV set, the appropriate attributes are NEXTTYPE and PREVTYPE.

COLS=n: The COLS attribute with value “n” can be added to certain tags to allow multiple columns of text to freely flow across the page, like in a newspaper.

LMARGIN/RMARGIN: The LMARGIN/RMARGIN attributes are used to set the absolute or relative margin of text with respect to the left or right sides of the display.

INDENT=N: The INDENT attribute with a value of N is used on the <P> tags to specify a numeric (pixel) indentation to use for the first line of a paragraph. This allows book-like setting of paragraphs.

KEEPTOGETHER: The KEEPTOGETHER specifies a logical chunk of text that is kept on the same page if possible.

MESSAGE=S: The MESSAGE attribute with a value of “S” specifies a message “S” to display when changing pages at the bookstore, instead of just saying “Communicating with bookstore”.

PROMPT=S: The PROMPT attribute with a value of “S” can be used for the text <INPUT> tags. The prompt is displayed on the virtual keyboard, so the user knows what they are entering information about.

SHOWSLIP: The SHOWSLIP attribute, in conjunction with YESBUTTON, NOBUTTON and NOHREF, is used to show a slip from an anchor tag, or cause a slip to appear immediately on going to a page, and to set actions and text for two buttons on the slip.

SECURE: The SECURE attribute specified on a <FORM> tag identifies this as a form whose data should be encrypted with the session key before transmittal to the bookstore.

FIG. 3B is a flowchart illustrating a process to process tags according to one embodiment of the invention.

Upon START, the process 300 determines if the next hypertext tag is being processed (Block 302). If not, the process 300 is terminated. If the next hypertext tag is being processed, the process 300 determines if the tag is one of the format or pagination tags (Block 304). If not, the process 300 proceeds and processes the tag as standard hypertext tags (Block 308). The process 300 is then terminated. If the tag is one of the format or pagination tags, the process 300 proceeds to process the tag operation according to the tag type (Block 306). The process 300 is then terminated.

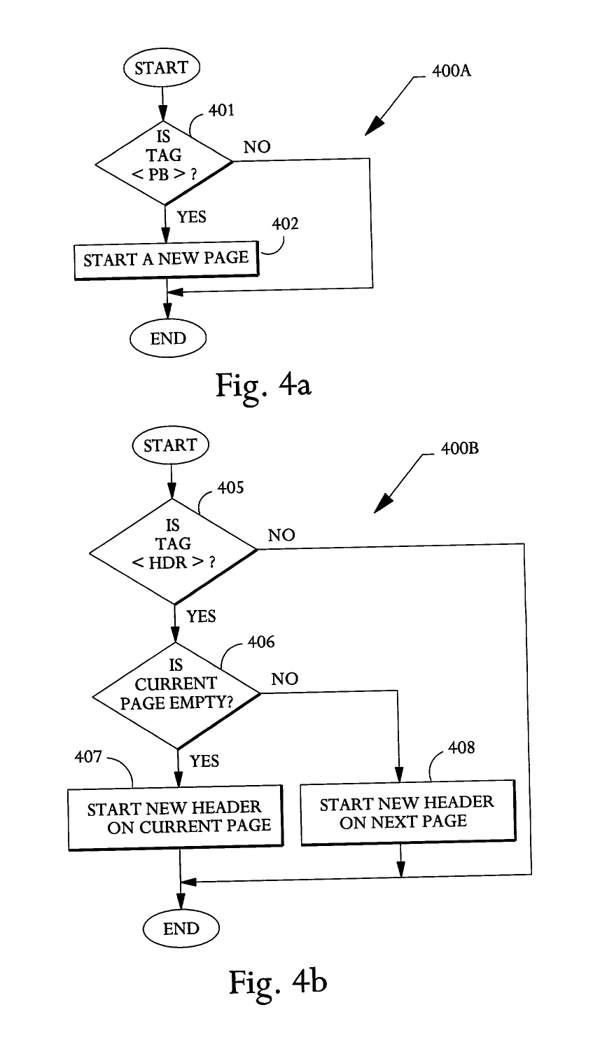

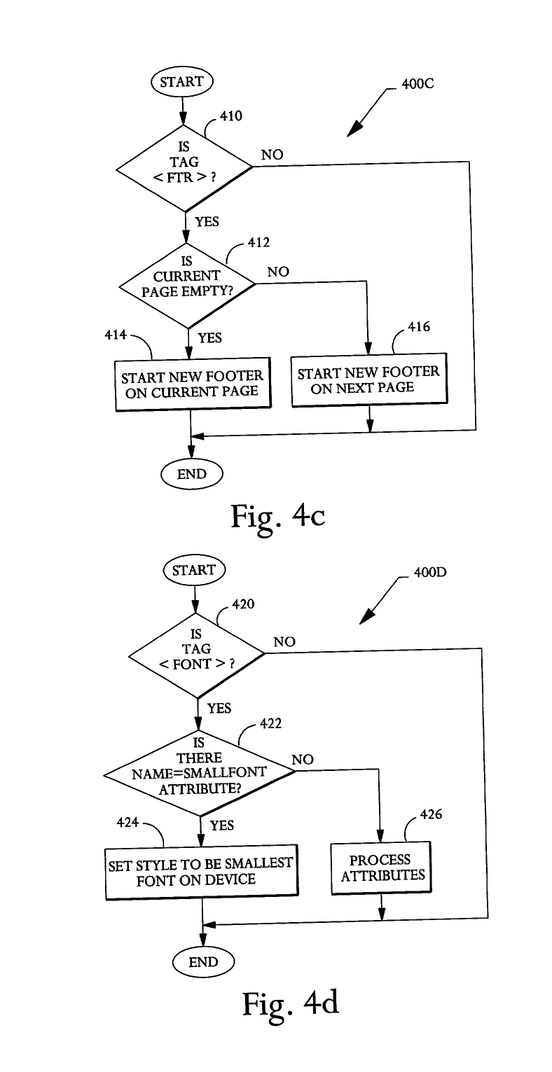

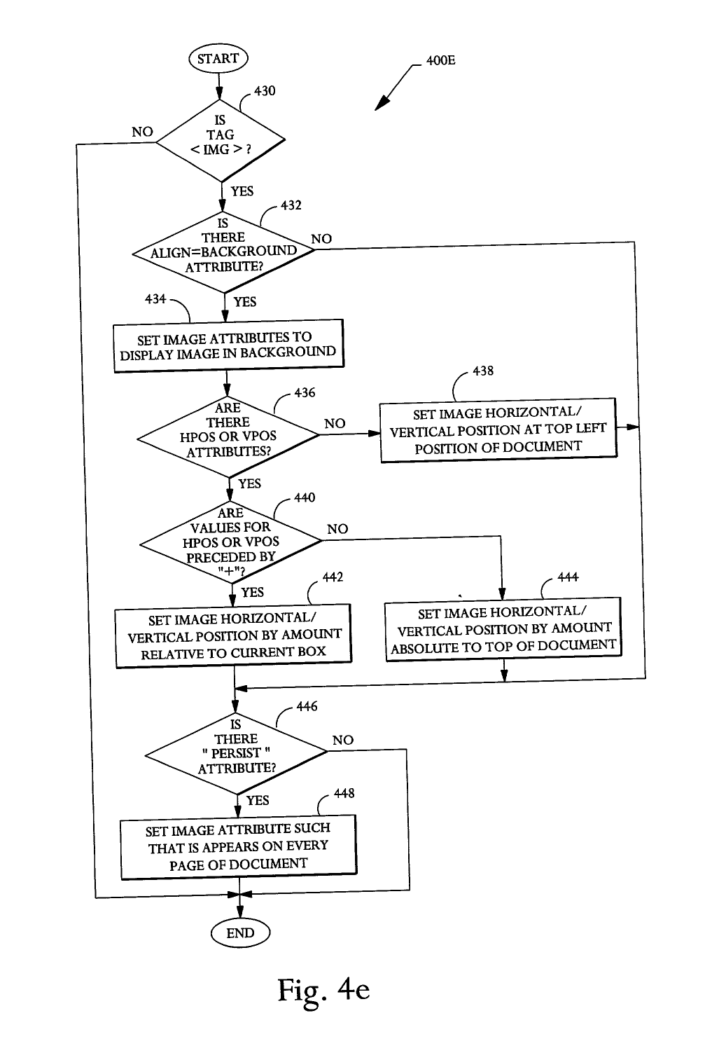

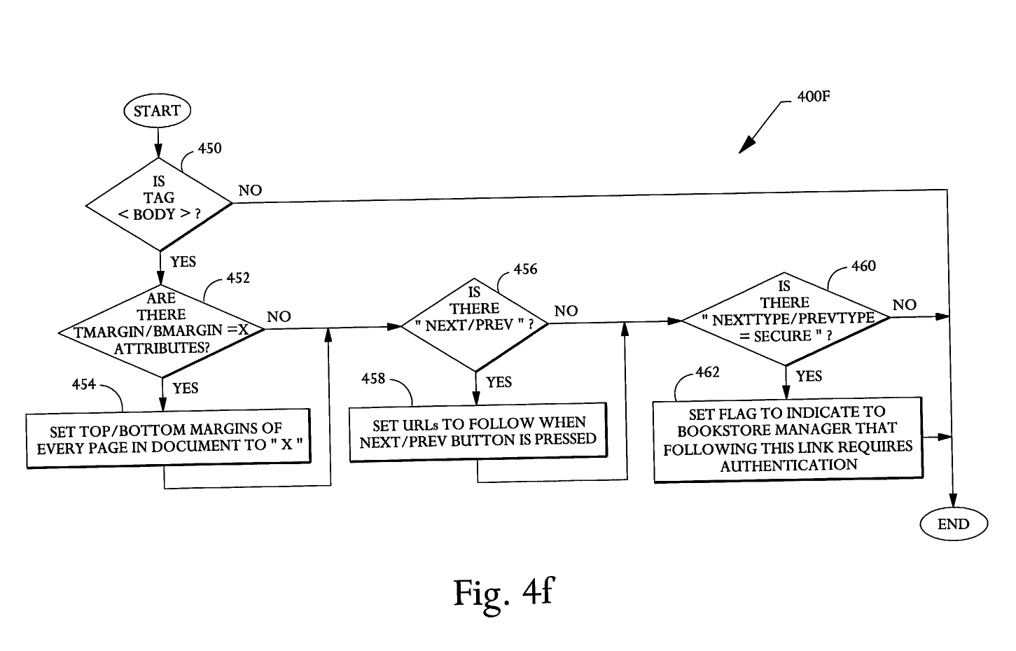

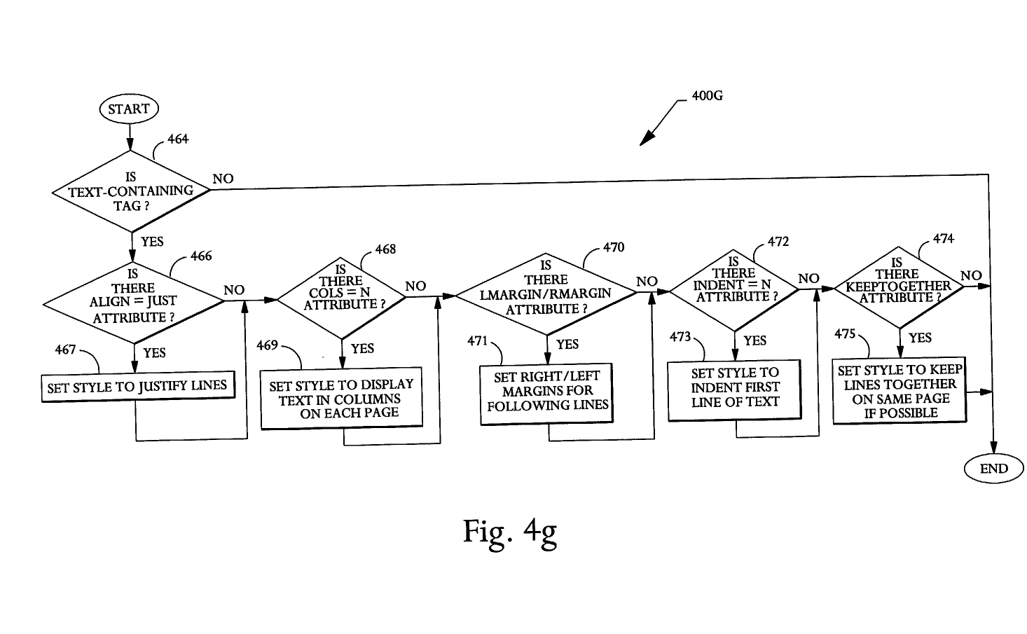

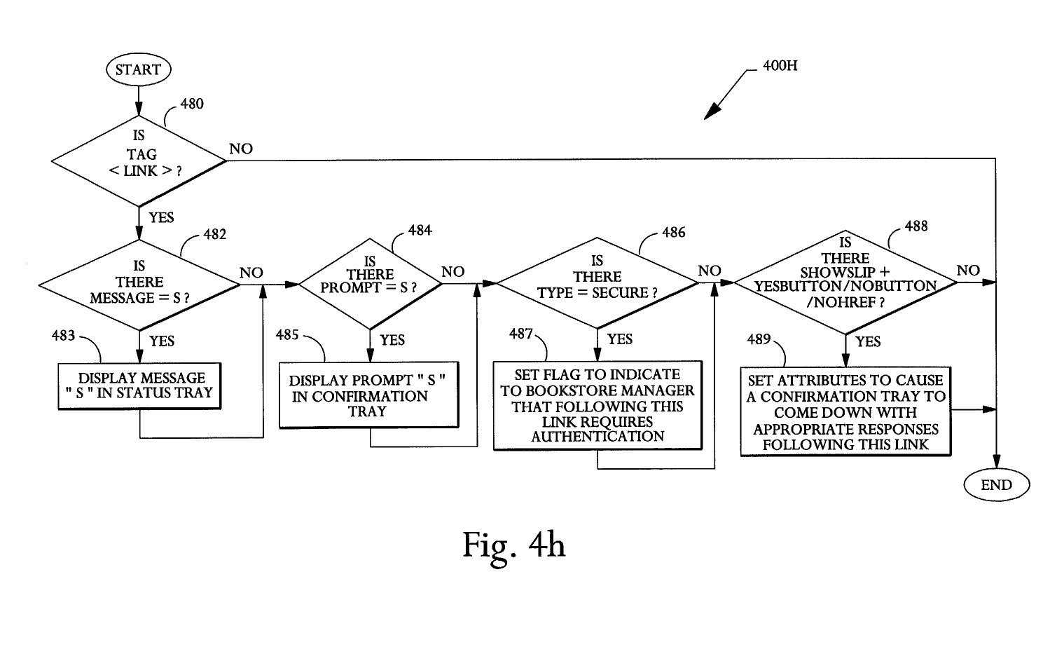

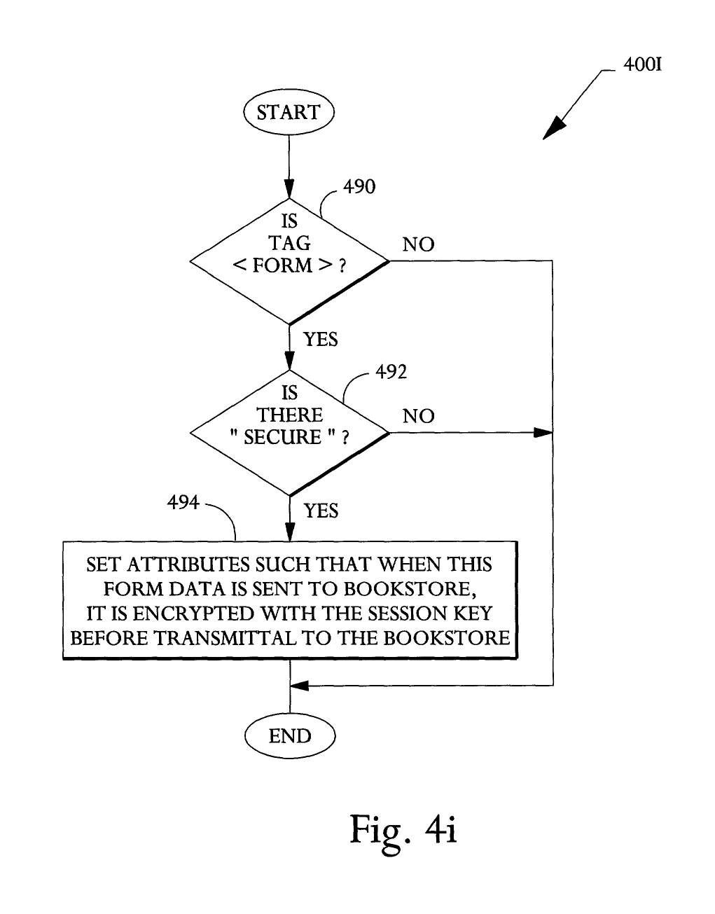

FIG. 4A is a flowchart illustrating a process 400A to perform a page break operation according to one embodiment of the invention.

Upon START, the process 400A determines if the tag is a <PB> (page break) tag. If not, the process 400A is terminated. If it is a page break tag, the process 400A starts a new page on the document (Block 402). The process 400A is then terminated.

FIG. 4B is a flowchart illustrating a process 400B to perform a header operation according to one embodiment of the invention.

Upon START, the process 400B determines if the tag is a <HDR> (header) tag (Block 405). If not, the process 400B is terminated. If it is a header tag, the process 400B determines if the current page is empty (Block 406). If the current page is not empty, the process 400B starts a new header on the next page (Block 408) and is then terminated. If the current page is empty, the process 400B starts a new header on the current page (Block 407) and is then terminated.

FIG. 4C is a flowchart illustrating a process 400C to perform a footer operation according to one embodiment of the invention.

Upon START, the process 400C determines if the tag is a <FTR> (footer) tag (Block 420). If not, the process 400C is terminated. If it is a footer tag, the process 400C determines if the current page is empty (Block 412). If the current page is not empty, the process 400C starts a new footer on the next page (Block 416) and is then terminated. If the current page is empty, the process 400C starts a new footer on the current page (Block 414) and is then terminated.

FIG. 4D is a flowchart illustrating a process 400D to perform a font operation according to one embodiment of the invention.

Upon START, the process 400D determines if the tag is a <FONT> (font) tag (Block 420). If not, the process 400D is terminated. If it is a font tag, the process 400 D determines if there is a NAME attribute with a SMALLFONT value (Block 422). If not, the process 400D performs standard operations for the font tag attributes (Block 426) and is then terminated. If there is a NAME attribute with a SMALLFONT value, the process 400D sets the style to be the smallest font on the device (Block 424) and is then terminated.

FIG. 4E is a flowchart illustrating a process 400E to perform an image operation according to one embodiment of the invention.

Upon START, the process 400E determines if the tag is an<IMG> (image) tag (Block 430). If not, the process 400E is terminated. If it is an image tag, the process 400E determines if there is an ALIGN attribute with a BACKGROUND value (Block 432). If no, the process 400E goes to block 446. If there is an ALIGN attribute with a BACKGROUND value, the process 400E sets the image attributes to display the image in the background (Block 434).

Then, the process 400E determines if there are HPOS/VPOS attributes. If not, the process 400E sets the image horizontal and vertical positions at the top left position of the document (Block 438) and then proceeds to block 446. If there are HPOS/VPOS attributes, the process 400E determines if there are + preceding these values. If not, the process 400E sets the image horizontal and vertical positions by an amount absolute to top of the document (Block 444). If there is a “+” preceding these values, the process 400E sets the image horizontal and vertical positions by an amount relative to the current box (Block 442).

Next, the process 400E determines if there is a PERSIST attribute (Block 446). If no, the process 400E is terminated. If there is a PERSIST attribute, the process 400E sets the image attribute such that it appears on every page of the document (Block 448). The process 400E is then terminated.

FIG. 4F is a flowchart illustrating a process 400F to perform a body operation according to one embodiment of the invention.

Upon START, the process 400F determines if the tag is a <BODY> (body) tag (Block 450). If no, the process 400F is terminated. If it is a body tag, the process 400F determines if there are TMARGIN/BMARGIN attributes with an “X” value (Block 452). If no, the process 400E goes to block 456. If there are TMARGIN/BMARGIN attributes with an “X” value, the process 400F sets the top and bottom margins of every page in the document to the “X” value (Block 454) and then proceeds to block 456.

At block 456, the process 400F determines if there is a NEXT/PREV attribute. If no, the process 400F goes to block 460. If there is a NEXT/PREV attribute, the process 400F sets the URLs to follow when the NEXT/PREV button is pressed on the device (Block 458).

At block 460, the process 400F determines if there is a NEXTTYPE/PREVTYPE attribute with a SECURE value. If no, the process 400F is terminated. If there is a NEXTTYPE/PREVTYPE attribute with a SECURE value, the process 400F sets a flag to indicate to the bookstore manager that the transaction that follows this link requires user authentication (Block 462). The process 400F is then terminated.

FIG. 4G is a flowchart illustrating a process 400G to perform a text-containing operation according to one embodiment of the invention.

Upon START, the process 400G determines if the tag is a text-containing tag (Block 464). If no, the process 400G is terminated. If it is a text-containing tag, the process 400G determines if there is an ALIGN attribute with a JUST value (Block 466). If no, the process 400G goes to block 468. If there is an ALIGN attribute with a JUST value, the process 400G sets the style to justify the lines (Block 467) and then goes to block 468.

At block 468, the process 400G determines if there is a COLS attribute with an N value. If no, the process 400G goes to block 470. If there is a COLS attribute with an N value, the process 400G sets the style to display the text in “N” columns on each page (Block 469) and then goes to block 470.

At block 470, the process 400G determines if there is a LMARGIN/RMARGIN attribute. If no, the process 400G goes to block 472. If there is a LMARGIN/RMARGIN attribute, the process 400G sets the right/left margins for the following lines (Block 471) and then goes to block 472.

At block 472, the process 400G determines if there is an INDENT attribute with an N value. If no, the process 400G goes to block 474. If there is an INDENT attribute with an N value, the process 400G sets the style to indent the first line of text with an amount of N (Block 473) and then goes to block 474.

At block 474, the process 400G determines if there is a KEEPTOGETHER attribute. If no, the process 400G is terminated. If there is a KEEPTOGETHER attribute, the process 400G sets the style to keep the lines together on the same page if possible. Then the process 400G is terminated.

FIG. 4H is a flowchart illustrating a process 400H to perform a link operation according to one embodiment of the invention.

Upon START, the process 400H determines if the tag is a <LINK> (link) tag (Block 480). If no, the process 400H is terminated. If it is a link tag, the process 400H determines if there is a MESSAGE attribute with an S value. If no, the process 400H goes to block 484. If there is a MESSAGE attribute with an S value, the process 400H displays the message “S” in the status tray on the device (Block 483) and then goes to block 484.

At block 484, the process 400H determines if there is a PROMPT attribute with an S value. If not, the process 400H goes to block 486. If there is a PROMPT attribute with an S value, the process 400H displays the prompt “S” in the confirmation tray (Block 485) and then goes to block 486.

At block 486, the process 400H determines if there is a TYPE attribute with a SECURE value. If no, the process 400H goes to block 488. If there is a TYPE attribute with a SECURE value, the process 400H sets a flag to indicate to the bookstore manager that the transaction that follows this link requires user authentication (Block 487) and then goes to block 488.

At block 488, the process 400H determines if there is a SHOWSLIP attribute in conjunction with the YESBUTTON/NOBUTTON/NOHREF attributes. If no, the process 400H is terminated. If there is a SHOWSLIP attribute in conjunction with the YESBUTTON/NOBUTTON/NOHREF attributes, the process 400H sets attributes to cause a confirmation tray to come down with the appropriate responses following this link (Block 489). The process 400H is then terminated.

FIG. 4I is a flowchart illustrating a process 400I to perform a form operation according to one embodiment of the invention.

Upon START, the process 400I determines if the tag is a <FORM> (form) tag (Block 490). If no, the process 400I is terminated. If it is a form tag, the process 400I determines if there is a SECURE value. If no, the process 400I is terminated. If there is a SECURE value, the process 400I sets attributes such that when this form data is sent to the bookstore, it is encrypted with the session key before transmittal to the bookstore (Block 494). The process 4001 is then terminated.

The present invention provides a simple and efficient technique to automatically format the data using a hypertext language. The technique uses a parser to identify the format or pagination tags and perform an operation according to the identified formatting tag. A number of tags and attributes are provided to expand the capabilities and flexibility of the pagination and formatting of the hypertext document.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method for automatically formatting a hypertext document, the method comprising:
(a) parsing the hypertext document to identify a formatting tag; and
(b) performing a tag operation on the hypertext document according to the identified formatting tag to generate a formatted document.

2. The method of claim 1 wherein formatting tag is one of a page break tag, a header tag, a footer tag, a font tag, an image tag, a body tag, a text-containing tag, a link tag, and a form tag.

3. The method of claim 2 wherein performing a tag operation includes starting a new page when the identified formatting tag is the page break tag.

4. The method of claim 2 wherein performing a tag operation includes starting a new header when the identified formatting tag is the header tag.

5. The method of claim 2 wherein performing a tag operation includes starting a new footer when the identified formatting tag is the footer tag.

6. The method of claim 2 wherein performing a tag operation includes setting a font type when the identified formatting tag is the font tag.

7. The method of claim 2 wherein performing a tag operation includes setting an image attribute when the identified formatting tag is the image tag.

8. The method of claim 2 wherein performing a tag operation includes setting a body attribute when the identified formatting tag is the body tag.

9. The method of claim 2 wherein performing a tag operation includes setting a text attribute when the identified formatting tag is the text-containing tag.

10. The method of claim 2 wherein performing a tag operation includes setting a link attribute when the identified formatting tag is the link tag.

11. The method of claim 2 wherein performing a tag operation includes setting a form attribute when the identified formatting tag is the form tag.

12. The method of claim 2 further comprising:
(c) identifying an attribute associated with the identified flag; and
(d) performing an attribute operation according to the identified attribute.

13. The method of claim 12 further comprising:
(e) identifying a value associated with the identified attribute; and
(f) performing the attribute operation using the identified value.

14. The method of claim 13 wherein performing an attribute operation includes setting a smallest font size when the identified attribute is a NAME attribute having an identified SMALLFONT value.

15. The method of claim 13 wherein performing an attribute operation includes setting image attributes to display image in background when the identified tag is an image tag and the identified attribute is an ALIGN attribute having an identified BACKGROUND value.

16. The method of claim 13 wherein performing an attribute operation includes setting an image horizontal/vertical position by a predetermined amount when the identified tag is the image tag and the identified attribute is a ALIGN with HPOS/VPOS attribute.

17. The method of claim 16 wherein the predetermined amount is absolute to top of the formatted document when there is no+symbol preceding HPOS/VPOS; otherwise the predetermined amount is relative to current box.

18. The method of claim 13 wherein performing an attribute operation includes setting an image horizontal/vertical position at top left position of the formatted document when the identified tag is the image tag and the identified attribute is a ALIGN having no HPOS/VPOS attribute.

19. The method of claim 13 wherein performing an attribute operation includes setting image attributes on every page of the formatted document when the identified tag is the image tag and the identified attribute is PERSIST.

20. The method of claim 13 wherein performing an attribute operation includes setting a top margin to X on every page of the formatted document when the identified tag is a body tag and the identified attribute is a TMARGIN attribute having an identified X value.

21. The method of claim 13 wherein performing an attribute operation includes setting a bottom margin to X on every page of the formatted document when the identified tag is a body tag and the identified attribute is a BMARGIN attribute having an identified X value.

22. The method of claim 13 wherein performing an attribute operation includes setting a Uniform Resource Locator (URL) address to follow forward when the identified tag is a body tag and the identified attribute is a NEXT attribute.

23. The method of claim 13 wherein performing an attribute operation includes setting a Uniform Resource Locator (URL) address to follow backward when the identified tag is a body tag and the identified attribute is a PREV attribute.

24. The method of claim 13 wherein performing an attribute operation includes informing a manager that a next link that follows a current link requires user authentication when the identified tag is a body tag and the identified attribute is a NEXTTYPE attribute having an identified SECURE value.

25. The method of claim 13 wherein performing an attribute operation includes informing a manager that a previous link that follows a current link requires user authentication when the identified tag is a body tag and the identified attribute is a PREVTYPE attribute having an identified SECURE value.

26. The method of claim 13 wherein performing an attribute operation includes justifying text lines when the identified tag is the text-containing tag and the identified attribute is a ALIGN with a JUST value.

27. The method of claim 13 wherein performing an attribute operation includes arranging text in N columns when the identified tag is the text-containing tag and the identified attribute is a COLS attribute with an N value.

28. The method of claim 13 wherein performing an attribute operation includes setting a right margin for following lines when the identified tag is the text-containing tag and the identified attribute is a RMARGIN attribute.

29. The method of claim 13 wherein performing an attribute operation includes setting a left margin for following lines when the identified tag is the text-containing tag and the identified attribute is a LMARGIN attribute.

30. The method of claim 13 wherein performing an attribute operation includes indenting a first line of text by an N amount when the identified tag is the text-containing tag and the identified attribute is an INDENT attribute having an identified N value.

31. The method of claim 13 wherein performing an attribute operation includes keeping lines on same page if possible when the identified tag is the text-containing tag and the identified attribute is a KEEPTOGETHER attribute.

32. The method of claim 13 wherein performing an attribute operation includes displaying a message S in a status tray when the identified tag is the link tag and the identified attribute is a MESSAGE attribute having an S value.

33. The method of claim 13 wherein performing an attribute operation includes displaying a prompt S in a confirmation tray when the identified tag is the link tag and the identified attribute is a PROMPT attribute having an identified S value.

34. The method of claim 13 wherein performing an attribute operation includes informing a manager that a next link that follows a current link requires user authentication when the identified tag is a link tag and the identified attribute is a TYPE attribute having an identified SECURE value.

35. The method of claim 13 wherein performing an attribute operation includes causing a confirmation tray to come down with an appropriate response when the identified tag is a link tag and the identified attribute is a SHOWSLIP attribute in conjunction with one of a YESBUTTON, a NOBUTTON, and a NOHREF attributes.

36. The method of claim 13 wherein performing an attribute operation includes encrypting a form data before transmittal to a server when the identified tag is a form tag having an identified SECURE value.

37. A machine readable medium having embodied thereon a computer program for processing by a processor to automatically format a hypertext document, the computer program comprising:
(a) a first code segment for parsing the hypertext document to identify a formatting tag; and
(b) a second code segment for performing a tag operation on the hypertext document according to the identified formatting tag to generate a formatted document.

38. The machine readable medium of claim 37 wherein the formatting tag is one of a page break tag, a header tag, a footer tag, a font tag, an image tag, a body tag, a text-containing tag, a link tag, and a form tag.

39. The machine readable medium of claim 38 wherein the second code segment starts a new page when the identified formatting tag is the page break tag.

40. The machine readable medium of claim 38 wherein the second code segment starts a new header when the identified formatting tag is the header tag.

41. The machine readable medium of claim 38 wherein the second code segment starts a new footer when the identified formatting tag is the footer tag.

42. The machine readable medium of claim 38 wherein the second code segment causes setting a font type when the identified formatting tag is the font tag.

43. The machine readable medium of claim 38 wherein the second code segment causes setting an image attribute when the identified formatting tag is the image tag.

44. The machine readable medium of claim 38 wherein the second code segment causes setting a body attribute when the identified formatting tag is the body tag.

45. The machine readable medium of claim 38 wherein the second code segment causes setting a text attribute when the identified formatting tag is the text-containing tag.

46. The machine readable medium of claim 38 wherein the second code segment causes setting a link attribute when the identified formatting tag is the link tag.

47. The machine readable medium of claim 38 wherein the second code segment causes setting a form attribute when the identified formatting tag is the form tag.

48. The machine readable medium of claim 38 wherein the second code segment:
(c) identifies an attribute associated with the identified flag; and
(d) performs an attribute operation according to the identified attribute.

49. The machine readable medium of claim 48 wherein the second code segment:
(e) identifies a value associated with the identified attribute; and
(f) performs the attribute operation using the identified value.

50. The machine readable medium of claim 49 wherein the second code segment causes setting a smallest font size when the identified attribute is a NAME attribute having an identified SMALLFONT value.

51. The machine readable medium of claim 49 wherein the second code segment causes setting image attributes to display image in background when the identified tag is an image tag and the identified attribute is an ALIGN attribute having an identified BACKGROUND value.

52. The machine readable medium of claim 49 wherein the second code segment causes setting an image horizontal/vertical position by a predetermined amount when the identified tag is the image tag and the identified attribute is a ALIGN with HPOS/VPOS attribute.

53. The machine readable medium of claim 52 wherein the predetermined amount is absolute to top of the formatted document when there is no + symbol preceding HPOS/VPOS; otherwise the predetermined amount is relative to current box.

54. The machine readable medium of claim 50 wherein the second code segment causes setting an image horizontal/vertical position at top left position of the formatted document when the identified tag is the image tag and the identified attribute is a ALIGN having no HPOS/VPOS attribute.

55. The machine readable medium of claim 49 wherein the second code segment causes setting image attributes on every page of the formatted document when the identified tag is the image tag and the identified attribute is PERSIST.

56. The machine readable medium of claim 49 wherein the second code segment causes setting a top margin to X on every page of the formatted document when the identified tag is a body tag and the identified attribute is a TMARGIN attribute having an identified X value.

57. The machine readable medium of claim 49 wherein the second code segment causes setting a bottom margin to X on every page of the formatted document when the identified tag is a body tag and the identified attribute is a BMARGIN attribute having an identified X value.

58. The machine readable medium of claim 49 wherein the second code segment causes setting a Uniform Resource Locator (URL) address to follow forward when the identified tag is a body tag and the identified attribute is a NEXT attribute.

59. The machine readable medium of claim 49 wherein the second code segment causes setting a Uniform Resource Locator (URL) address to follow backward when the identified tag is a body tag and the identified attribute is a PREV attribute.

60. The machine readable medium of claim 49 wherein the second code segment causes informing a manager that a next link that follows a current link requires user authentication when the identified tag is a body tag and the identified attribute is a NEXTTYPE attribute having an identified SECURE value.

61. The machine readable medium of claim 49 wherein the second code segment causes informing a manager that a previous link that follows a current link requires user authentication when the identified tag is a body tag and the identified attribute is a PREVTYPE attribute having an identified SECURE value.

62. The machine readable medium of claim 49 wherein the second code segment causes justifying text lines when the identified tag is the text-containing tag and the identified attribute is a ALIGN with a JUST value.

63. The machine readable medium of claim 49 wherein the second code segment arranges text in N columns when the identified tag is the text-containing tag and the identified attribute is a COLS attribute with an N value.

64. The machine readable medium of claim 49 wherein the second code segment sets a right margin for following lines when the identified tag is the text-containing tag and the identified attribute is a RMARGIN attribute.

65. The machine readable medium of claim 49 wherein the second code segment sets a left margin for following lines when the identified tag is the text-containing tag and the identified attribute is a LMARGIN attribute.

66. The machine readable medium of claim 49 wherein the second code segment causes indenting a first line of text by an N amount when the identified tag is the text-containing tag and the identified attribute is an INDENT attribute having an identified N value.

67. The machine readable medium of claim 49 wherein the second code segment causes keeping lines on same page if possible when the identified tag is the text-containing tag and the identified attribute is a KEEPTOGETHER attribute.

68. The machine readable medium of claim 49 wherein the second code segment causes displaying a message S in a status tray when the identified tag is the link tag and the identified attribute is a MESSAGE attribute having an S value.

69. The machine readable medium of claim 49 wherein the second code segment causes displaying a prompt S in a confirmation tray when the identified tag is the link tag and the identified attribute is a PROMPT attribute having an identified S value.

70. The machine readable medium of claim 49 wherein the second code segment causes informing a manager that a next link that follows a current link requires user authentication when the identified tag is a link tag and the identified attribute is a TYPE attribute having an identified SECURE value.

71. The machine readable medium of claim 49 wherein the second code segment causes a confirmation tray to come down with an appropriate response when the identified tag is a link tag and the identified attribute is a SHOWSLIP attribute in conjunction with one of a YESBUTTON, a NOBUTTON, and a NOHREF attributes.

72. The machine readable medium of claim 49 wherein the second code segment causes encrypting a form data before transmittal to a server when the identified tag is a form tag having an identified SECURE value.
